(19) United States
(12) Patent Application Publication
(10) Pub. No.: US 2026/0088314 A1
(43) Pub. Date: Mar. 26, 2026

(54) BIPOLAR FLOW FIELD PLATE FOR FUEL CELLS

(71) Applicant: BALLARD POWER SYSTEMS INC., Burnaby (CA)

(72) Inventor: Pouria KHOSHNEVISRAD, Burnaby (CA)

(21) Appl. No.: 19/109,072

(22) PCT Filed: Sep. 6, 2023
(86) PCT No.: PCT/US2023/032095

§ 371 Date: Mar. 5, 2025

Related U.S. Application Data
(60) Provisional application No. 63/404,428, filed on Sep. 7, 2022.

(51) Int. Cl. H01M 8/0267; H01M 8/0258; H01M 8/1004; H01M 8/241

(52) U.S. Cl. CPC H01M 8/0267; H01M 8/0258; H01M 8/1004; H01M 8/241

(57) ABSTRACT

A bipolar flow field plate for an electrochemical fuel cell comprises fuel supply channels formed on the first surface of the bipolar flow field plate, having a constant cross-section along the length of bipolar flow field plate, oxidant supply channels formed on another surface of the bipolar flow field plate, opposite to the first surface, and having a constant cross-section along the length of the bipolar flow field plate and coolant flow channels provided within the bipolar flow field plate, wherein at least two adjacent coolant flow channels in the active area of the bipolar flow field plate communicate to each other through a flow sharing portion. The size of the flow sharing portion can vary according to the coolant flow sharing needs. The projections of the bipolar flow field plate which form the coolant flow channels can be provided with pillars along the flow sharing portions of the plate.

### BACKGROUND

### Technical Field

The present invention relates to electrochemical fuel cells and, in particular, to a novel design for a bipolar flow field plate used in a solid polymer electrolyte fuel cell for improving the flow sharing, reducing the pressure drop and increasing the heat transfer rate in the coolant flow channels to thereby increase the performance of the fuel cell and the lifetime of the membrane electrode assembly in the fuel cell through a better temperature management.

### Description of the Related Art

Fuel cell systems convert reactants, namely fuel and oxidant, to electricity and are therefore used as power supplies in numerous applications, such as automobiles and stationary power plants. Such systems are a good solution for economically delivering power with environmental benefits.

Fuel cells generally employ an electrolyte disposed between two electrodes, namely a cathode and an anode. A catalyst typically induces the electrochemical reactions at the electrodes. Preferred fuel cell types include solid polymer electrolyte fuel cells that comprise a solid polymer electrolyte, for example a proton exchange membrane. Proton exchange membrane fuel cells employ a membrane electrode assembly (“MEA”) having a proton exchange membrane (“PEM”) (also known as an ion-exchange membrane) interposed between an anode electrode and a cathode electrode. The anode electrode and respectively the cathode electrode each include a catalyst and a microporous, electrically conductive substrate, such as carbon fiber paper or carbon cloth, which provides mechanical support to the membrane and is employed for reactant distribution, thus serving as a gas diffusion layer (GDL).

The membrane electrode assembly is typically disposed between two electrically conductive flow field plates or separator plates and form a fuel cell. The flow field plates or separator plates act as current collectors, provide support for the electrodes, and provide flow fields for the supply of reactants, such as fuel and oxidant, and removal of excess reactants and products that are formed during operation, such as product water. The flow fields comprise fluid distribution channels separated by landings which contact the electrodes of the membrane electrode assembly when assembled into a fuel cell. The landings act as mechanical supports for the gas diffusion layers and provide electrical contact thereto. A fuel cell stack comprises several fuel cells compressed between endplates.

In a fuel cell stack, coolant needs to be provided between the adjacent membrane electrode assemblies in the stack of fuel cells to prevent the raise in temperature of the fuel cell stack due to the reactions taking place at the electrodes.

The coolant is supplied to the stack for this purpose through the coolant flow channels provided in the bipolar flow field plates. A bipolar flow field plate is placed between two adjacent membrane electrode assemblies in the stack and has fuel supply channels on the side of the plate facing the anode of one membrane electrode assembly, oxidant supply channels on the opposite side of the plate facing the cathode of the adjacent electrode assembly, and coolant flow channels which are additional flow channels provided within the body of the plate. Such a bipolar flow field plate can be formed as one plate having fuel, oxidant supply channels on each side of the plate and coolant flow channels within the plate, or as two separate plates provided with fuel and oxidant supply channels and being assembled together to form the coolant flow channels between them.

In order to properly manage the temperature of the membrane electrode assemblies in the stack, a uniform coolant flow along the surfaces of the bipolar flow field plates and preventing the pressure drop within the coolant flow channels should be ensured.

It is known in the art to address the problem of pressure drop in the coolant flow channels by increasing the size of the coolant flow channels which leads to increasing the thickness of the bipolar plate and therefore reducing the power density of the fuel cell or, alternatively it can lead to increasing the distance between the adjacent coolant and respectively the reactant channels (channel pitch).

In some cases, the degraded cooling performance is caused by the air bubbles which are mixed into the refrigerant channels inside the power generation portion of the fuel cell. In order to solve this problem U.S. Pat. No. 10,879,541 describes separators having refrigerant channels inside the power generation portion of the fuel cell which communicate with each other via constricted portions of the channels where the projections of the channels are smaller in size than the projections of the channels in the non-constricted portions of the channels to allow the channels to communicate with each other. These constricted portions are disposed at a predetermined interval along the length of the refrigerant channels in the horizontal direction Y, as shown in FIG. 4 of this patent and allow the air bubbles from refrigerant to move up from the refrigerant channels on the lower level of the stack to the those on the upper level and to reach the refrigerant outside of the refrigerant channel outside of the power generation portion and to be discharged to the outside through the refrigerant outlet manifold.

The communication between the coolant flow channels through the constricted portions of the channels in this United States patent is designed to solve a different problem than preventing the pressure drop within the coolant flow channels and to have a uniform coolant flow sharing. Also, the cross-section of the refrigerant channels outside of the power generation portion is larger than that of the refrigerant channels inside the power generation portion to allow the refrigerant to flow faster through the refrigerant channel outside of the power generation portion so that the air bubbles collected in the refrigerant channel outside of the power generation portion can be quickly discharged to the outside. This involves also changing the cross-section of the oxidant gas channels as clearly shown in FIG. 5.

There is still a need to solve the problem of pressure drop in the coolant flow channels and improve flow sharing between the coolant flow channels. The present invention addresses this need and provides further related advantages.

### BRIEF SUMMARY

Briefly summarized, a bipolar flow field plate for an electrochemical fuel cell of the present invention comprises:
a first plate and a second plate;
fuel supply channels formed on a first external surface of the first plate, the fuel supply channels having a constant cross-section along the length of the bipolar flow field plate;
oxidant supply channels formed on a second external surface of the second plate, the second external surface opposite to the first external surface of the first plate, the oxidant supply channels having a constant cross-section along the length of the bipolar flow field plate; and
coolant flow channels provided within the bipolar flow field plate formed between a first internal surface of the first plate and by a second internal surface of the second plate,
wherein at least two adjacent coolant flow channels in the active area of the bipolar flow field plate communicate to each other through a flow sharing portion, thereby sharing the coolant flow between them.

The coolant flow channels are formed by projections and recesses on the first internal surface of the first plate and by projections and recesses on the second internal surface of the second plate, the projections on the first internal surface of the first plate facing or being in contact with the projections on the second internal surface of the second plate.

In some embodiments, the second internal surface of the second plate is planar and the coolant flow channels are formed by the projections and recesses on the first internal surface of the first plate and by the second internal surface of the second plate.

In some embodiments, all the adjacent coolant flow channels in the active area of the bipolar flow field plate communicate to each other through flow sharing portions, each flow sharing portion connecting two adjacent coolant flow channels.

In some embodiments, only selected adjacent coolant channels communicate to each other through flow sharing portions.

Furthermore, at least one of the flow sharing portions which allow the coolant flow sharing between adjacent coolant flow channels can be different in size (e.g. height) than the other flow sharing portions, thereby allowing more or less flow sharing between adjacent coolant flow channels.

In some embodiments, the first internal surface of the first plate is provided with pillars along the length of the projections which form the coolant flow channels, wherein the pillars make contact with the projections on the second internal surface of the second plate which form the coolant flow channels.

In other embodiments, when the second internal surface of the second plate is planar, the first internal surface of the first plate is provided with pillars along the length of the projections of the first internal surface of the first plate which form the coolant flow channels, wherein the pillars make contact with the planar surface of the second internal surface of the second plate.

In all embodiments, the pillars can have a circular cross-section, an oval shaped cross-section or a triangular shaped cross-section.

The pillars can be placed at an equal distance from each other along a projection of the first internal surface of the first plate or at a different distance from each other according to the flow sharing needs and the mechanical strength of the plate. Some of the pillars on one projection of the first internal surface of the first plate or on the second internal surface of the second plate can be different in size or can have a different shape than the pillars on the same projection. The pillars on one projection of the first plate can be different in size or can have a different shape than the pillars on a different projection of the first plate. At least some of the pillars do not make contact with the projections on the second internal surface of the second plate to allow coolant to flow from one coolant flow channel to an adjacent coolant flow channel.

The present invention further describes an electrochemical fuel cell stack, comprising more than one fuel cell comprising a membrane electrode assembly wherein each membrane electrode assembly is placed between two bipolar flow field plates, each bipolar flow field plate comprising:
a first plate;
a second plate;
fuel supply channels formed on a first external surface of the first plate, the fuel supply channels having a constant cross-section along the length of bipolar flow field plate;
oxidant supply channels formed on a second external surface of a second plate, opposite to the first external surface of the first plate, the oxidant supply channels having a constant cross-section along the length of the bipolar flow field plate; and
coolant flow channels provided within the bipolar flow field plate formed by projections and recesses on a first internal surface of the first plate and by projections and recesses on a second internal surface of the second plate,
wherein at least two adjacent coolant flow channels in the active area of a bipolar flow field plate in the stack communicate to each other through a flow sharing portion, thereby sharing the coolant flow between them.

In some embodiments, each of the coolant flow channels in the active area of at least one bipolar flow field plate in the stack communicates to an adjacent coolant flow channel of the same bipolar flow field plate through a flow sharing.

In other embodiments, only selected adjacent coolant flow channels in the active area of at least one bipolar flow field plate in the stack communicate to each other through flow sharing portions.

In some embodiments, at least one of the flow sharing portions which allow the coolant flow sharing between adjacent coolant flow channels of one of the bipolar flow field plates in the stack is different in size (e.g. height) than the other flow sharing portions of the same bipolar flow field plate, thereby allowing more or less flow sharing between adjacent coolant flow channels.

In some embodiments, the first internal surface of the first plate of at least one bipolar flow field plate in the stack is provided with pillars along the length of the projections of the first internal surface of the first plate, wherein the pillars make contact with the projections on the second internal surface of the second plate.

The pillars in all the embodiments of the fuel cell stack can have a circular cross-section, an oval shaped cross-section, a triangular shaped cross-section, or any other shape designed shaped on the flow sharing requirements and mechanical strength considerations.

The pillars in all the embodiments of the fuel cell stack can be placed at an equal distance from each other along a projection of first internal surface of the first plate forming the coolant flow channels or at a difference distance from each other based on the flow sharing requirements, detected pressure drop and required mechanical strength of the plate.

In some embodiments of the present fuel cell stack some of the pillars on one projection of the first plate are different in size and/or shape than the pillars on the same projection.

In some embodiments of the present fuel cell stack the pillars on one projection of the first plate can be different in size or shape than the pillars of a different projection of the first plate.

These and other aspects of the invention will be evident upon reference to the following detailed description and attached drawings.

### DESCRIPTION OF THE DRAWINGS

FIGS. 1A and 1B show a tridimensional view of a bipolar flow field plate and respectively a cross-section through the bipolar flow field plate placed between two membrane electrode assemblies from a fuel cell stack according to a first embodiment of the present invention.

FIGS. 2A and 2B show a tridimensional view of a bipolar flow field plate placed between two membrane electrode assemblies from a fuel cell stack and respectively a cross-section through this assembly according to a second embodiment of the present invention.

FIG. 3A shows a tridimensional view of a bipolar flow field plate provided with pillars as further described in the present invention, the bipolar flow field plate being placed between the two adjacent membrane electrode assemblies in a stack of fuel cells according to a third embodiment of the present invention.

FIG. 3B shows a view of half of the bipolar flow field plate from FIG. 3A which shows the distribution of the pillars on the half of the bipolar flow field plate.

FIG. 3C shows a tridimensional view of half of a bipolar flow field plate provided with pillars of a different design.

FIG. 3D shows a view of half of a bipolar flow field plate according to another embodiment of the present invention where the shape of the pillars varies from one row of pillars to the other.

FIG. 3E shows a tridimensional view of another embodiment of the present invention showing a bipolar flow field plate provided with pillars and having coolant flow channels provided only on one side of the bipolar flow field plate.

FIGS. 4A and 4B show a tridimensional view and respectively a cross-sectional view a bipolar flow field plate according to another embodiment of the present invention.

FIG. 5 shows a cross-section through another embodiment of the bipolar flow field plate provided with pillars of different heights and shapes.

FIG. 6 shows a graphical representation of the deviation from the average coolant channel flow for a fuel cell from the prior art which has a bipolar flow field plate where none of the coolant flow channels do not communicate to each other.

### DETAILED DESCRIPTION

In the following description, certain specific details are set forth in order to provide a thorough understanding of the various embodiments. However, one skilled in the art will understand that the invention may be practiced without these details. In other instances, well-known structures associated with fuel cells, fuel cell stacks, and fuel cell systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to”. Also, reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

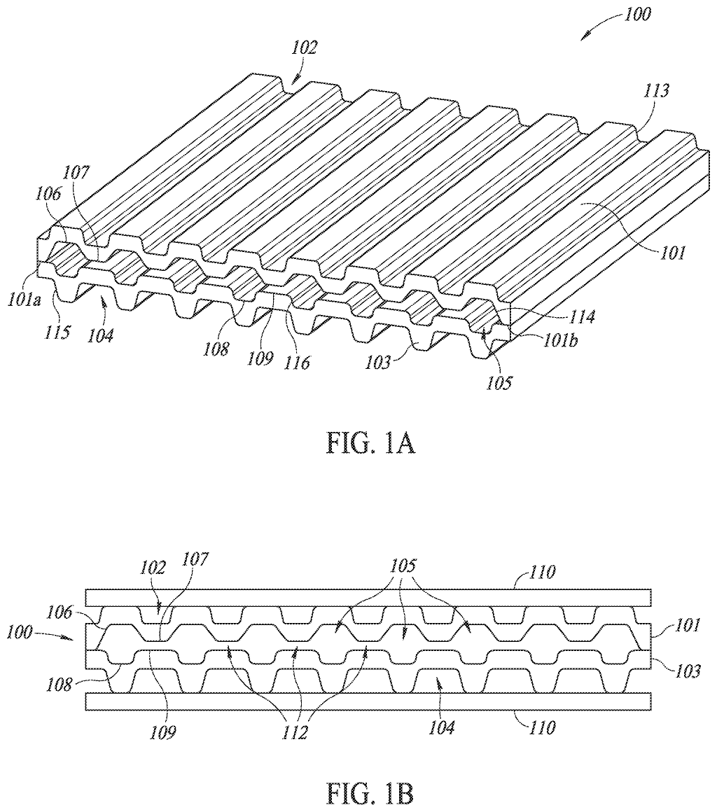

FIG. 1A illustrates a tridimensional view of a bipolar flow field plate 100 according to a first embodiment of the present invention. In this embodiment, the bipolar flow field plate 100 is formed by a first plate 101 provided with fuel supply channels 102 on the external surface 113 first, and a second plate 103 provided with oxidant supply channels 104 on the external surface 115. Coolant flow channels 105 are formed between the first plate 101 and the second plate 103 by the recesses 106 and the projections 107 of the first internal surface 114 of the first plate 101 and by the recesses 108 and the projections 109 of the second internal surface 116 of the second plate 103. The coolant flow channels have the same cross-section along the length of the bipolar flow field plate.

As illustrated in FIG. 1B, the bipolar flow field plate 100 is placed within a stack of fuel cells between two membrane electrode assemblies (MEAs) 110.

As illustrated in FIGS. 1A and 1B bipolar flow field plate 100 is made of two plates, the first plate 101 and the second plate 103, glued together at their ends. A person skilled in the art would understand that the bipolar field plate illustrated in FIGS. 1a and 1b can be made of two separate plates, or a single molded plate made of the first plate and second plate molded together, the single molded plate being provided with the fuel and oxidant flow channels formed by the projections and recesses provided on the external surfaces of the molded plate and with coolant flow channels formed by the projections and recesses provided on the internal surfaces of the molded plate as illustrated in this embodiment. These two options of the bipolar flow field plate being formed either of two plates glued together or a single molded plate, having the same channel configuration as described, are available for all the embodiments described here, even if not illustrated in the figures.

As illustrated in the figures, adjacent coolant flow channels 105 communicate to each other through flow sharing portions 112. This is different than the coolant flow channels known in the prior art where all the coolant flow channels are isolated from each other due to the shape of the first plate and of the second plate which allow the plates to contact each other on the portions between the adjacent coolant flow channels through the projections provided on the first and second plates.

In the embodiment illustrated in FIGS. 1A and 1B, each of the coolant flow channel in the bipolar flow field plate communicates with the adjacent coolant flow channel. This allows flow sharing of the coolant between the channels which reduces the fluid pressure drop within the coolant flow channels, ensures a more uniform cooling of the membrane electrode assembly and a higher heat transfer rate during operation.

A person skilled in the art would easily recognize that in the present invention the cross-section of the fuel supply channels and of the oxidant supply channels remains constant along the length of the flow field plate, as illustrated in the figures, and therefore the flow sharing between the adjacent coolant flow channels can be performed without affecting the flow of the fuel and oxidant flow through the fuel and oxidant supply channels since the pitch between the fuel and oxidant supply channels (the distance between the center line of a fuel or an oxidant supply channel and the center line of an adjacent fuel or respectively an oxidant supply channel) remains the same. Also, the pitch of the coolant flow channels (the distance between the center line of one coolant channel to the center line of an adjacent coolant channel) can be kept the same as for a bipolar flow field plate where the adjacent coolant flow channels are not fluidly connected through a flow sharing portion and also the thickness of the bipolar flow field plate does not need to be increased in order to provide these flow sharing portions between the adjacent coolant flow channels. Consequently, the dimensions of the fuel cell stack can be kept the same which helps to keep the fuel cell stacks smaller in volume while allowing the same performance because the reactant flow through the fuel and oxidant supply channels does not change. Furthermore, the present invention reduces parasitic losses because the coolant flow rate required for maintaining the stack temperature is reduced compared to the prior art.

As illustrated in FIGS. 1A and 1B the adjacent coolant flow channels 105 which communicate to each other stretch across the active area of the fuel cell where the fuel is supplied to a membrane electrode assembly 110 through the fuel supply channels 102 and the oxidant is supplied to another membrane electrode assembly 110 through the oxidant supply channels 104, during the operation of the fuel cell.

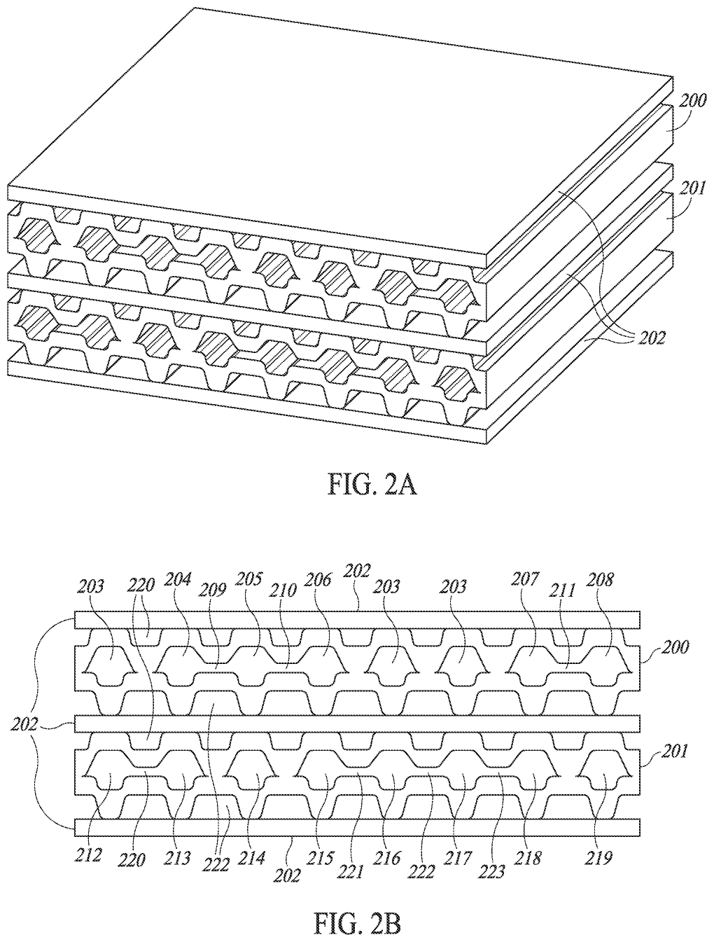

FIGS. 2A and 2B illustrate the tridimensional view and respectively the cross-sectional view of a second embodiment of the present invention, respectively two bipolar flow field plates 200 and 201, each bipolar flow field plate being placed between two membrane electrode assemblies 202. Each of the bipolar flow field plates 200 and 201 is provided with fuel supply channels 220 on a first external surface of the plate and oxidant supply channels 222 on the opposite external surface of the plate. The coolant flow channels 203 are formed between the recesses and projections on the first internal surface of the bipolar flow field plate and the recesses and projections on the second internal surface of the bipolar flow field plate as illustrated in the figure.

Some of the coolant flow channels 203 of bipolar flow field plate 200 are not connected to their respective adjacent coolant flow channels, similar to the known design of a bipolar flow field plate from the prior art. Each of the other coolant flow channels 204, 205, 206, and respectively 207 and 208 communicate to an adjacent coolant flow channel to provide coolant flow sharing between the channels. More specifically, coolant flow channels 204, 205 and 206 communicate to each other through the coolant flow sharing portions 209 and 210 without communicating with coolant flow channels 203 and coolant flow channels 207 and 208 also communicate to each other through flow sharing portions 211 without communicating with the adjacent coolant flow channel 203.

Bipolar flow field plate 201 is also provided with coolant flow channels, but as seen in FIGS. 2A and 2B, the pattern of connection between the adjacent coolant flow channels is different than the one for bipolar flow field plate 200. Coolant flow channels 214 and 219 are not connected to any of the adjacent coolant flow channels, while coolant flow channel 212 is connected with the adjacent coolant flow channel 213 through the flow sharing portion 220 and adjacent coolant flow channels 215, 216, 217 and 218 are connected to each other through flow sharing portions 221, 222 and 223.

From this embodiment it can be seen that the pattern of communication between the adjacent coolant flow channels can vary from one bipolar flow field plate to another bipolar flow field plate in the stack and it is designed to address specific requirements regarding the coolant pressure drop and a uniform cooling pattern for the stack which are factors determined experimentally and can vary from one stack to another, as further explained below.

As seen in FIGS. 2A and 2B, in this embodiment the bipolar flow field plates 200 and 201 are plates made of one piece, made for example by molding together a first plate and a second plate, to have the coolant flow channels and the fuel supply channels 220 and the oxidant supply channels 222 as shown. As can be seen in the figures, the thickness of the bipolar flow field plates and pitch of the coolant, fuel and oxidant supply channels is kept the same independent of the pattern of connecting the coolant flow channels and the cross-section of the fuel and oxidant supply channels is kept constant along the length of the bipolar flow field plate.

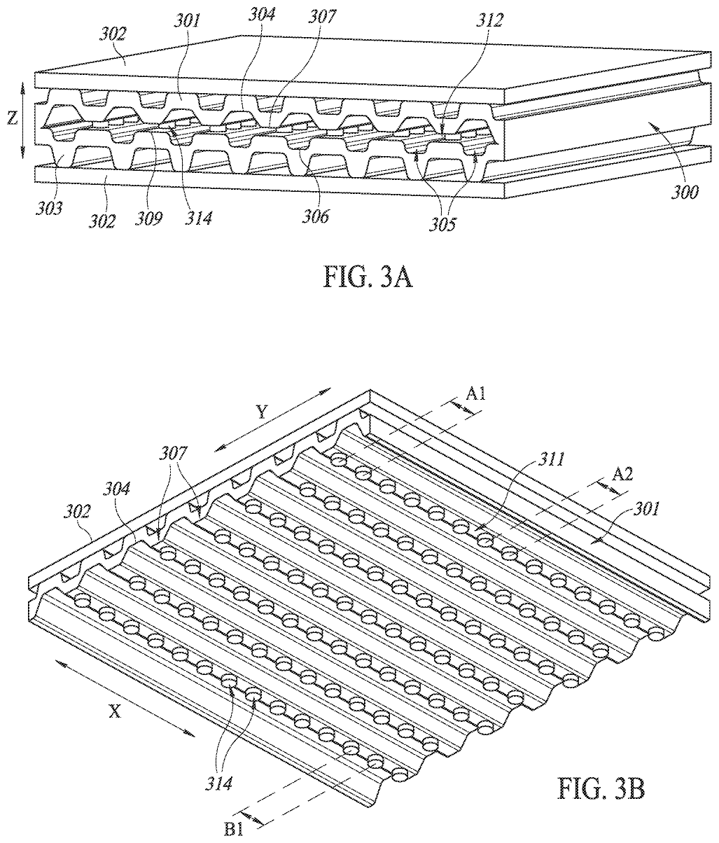

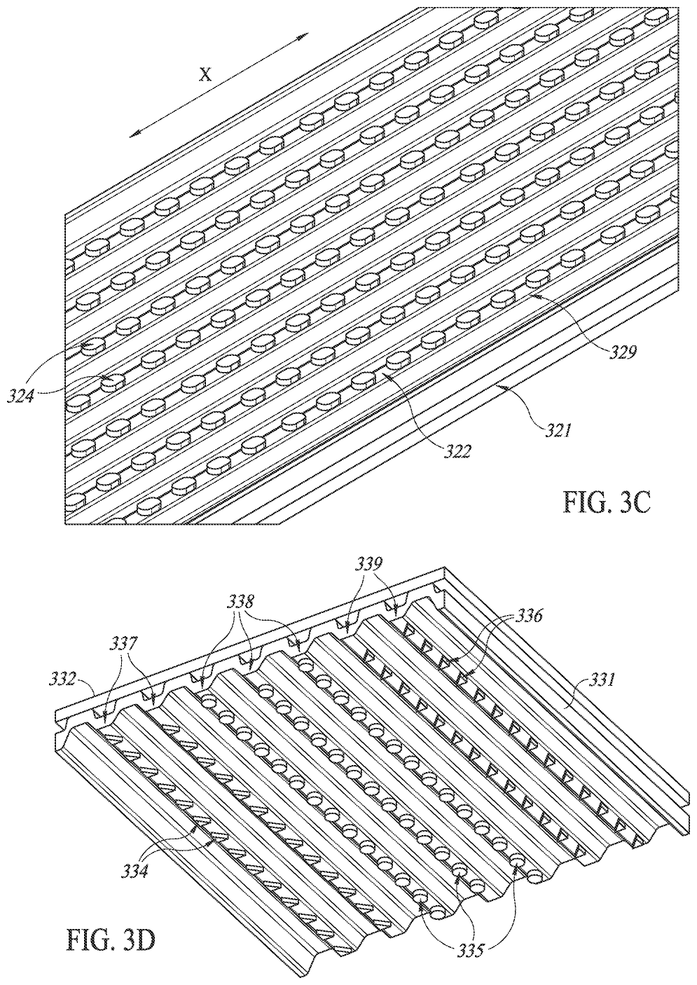

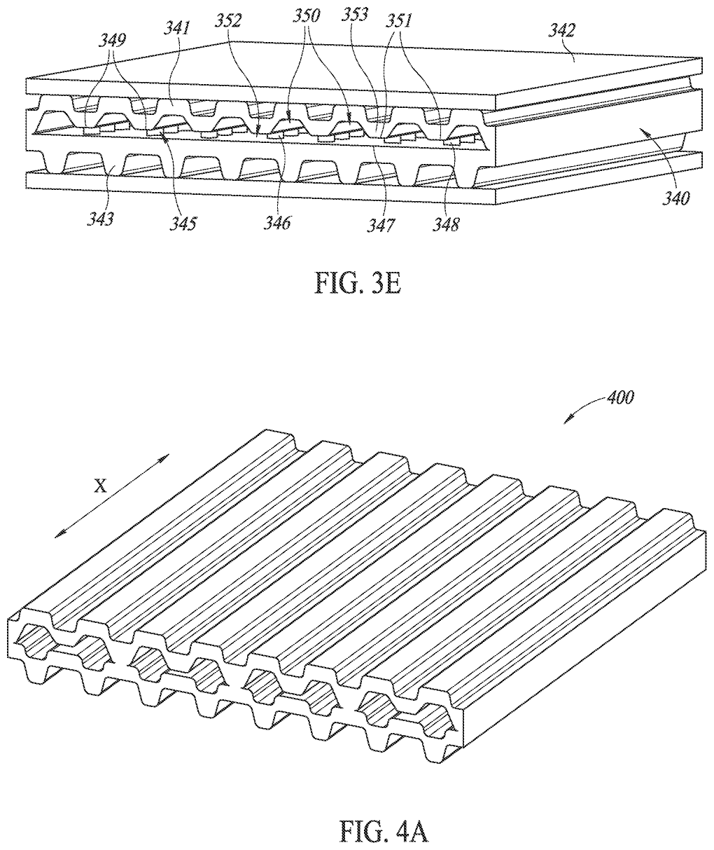

A few other embodiments of the present invention are illustrated in FIGS. 3A, 3B and 3C. In the embodiments illustrated in these figures the bipolar flow field plate is a molded plate made of a first plate and a second plate.

In the embodiment illustrated in FIGS. 3A and 3B bipolar flow field plate 300 is a molded plate made of a first plate 301 and at second plate 303 placed between two membrane electrode assemblies 302 and has coolant flow channels 305 which are formed between the first internal surface of the bipolar flow field plate and the second internal surface of the bipolar flow field plate by the projections (307, 309) and recesses (304, 306) on these internal surfaces. As the embodiment illustrated in FIG. 1, in this embodiment all the coolant flow channels 305 communicate to each other through flow sharing portions 312. The first plate 301 of the bipolar flow field plate 300 is provided with pillars 314 which are molded along the length of the projections 307 of the first plate 301 which form, together with recesses 304, the coolant flow channels 305. The pillars 314 make contact with the projections 309 of the second internal surface of the second plate 303. As better illustrated in FIG. 3B, in this embodiment the pillars 314 are formed along the length of each projection 307 (in the direction X), as a row of pillars, and, in this embodiment, they have a cylindrical shape with a circular cross-section. The coolant flow is shared between two adjacent coolant flow channels through the openings 311 between the pillars 314 along the flat portions of the projections 307 and 309 on the first and second plates 301 and 303.

In the embodiment illustrated in FIGS. 3A and 3B, all the pillars have the same dimensions and the same shape and are placed at equal distance from each other along the flat portions of the projections, that is, the distances A1, A2 and B1 are equal to each other. Also, as shown in FIG. 3B the pillars placed on different projections 307 are not aligned to each other in the Y direction. In some other embodiments, some of the pillars on one projection 307 are aligned in the Y direction with the pillars on another projection 307 of the first plate or with the pillars on all the other projections on the first plate and in other embodiments, only some of the pillars on one projection are aligned in the Y direction with the pillars on another projection.

A person skilled in the art would understand that the size, the positioning of the pillars along the width of the flat projections of the first or of the second plate of the bipolar flow field plate, the shape of the pillars and the distance between the pillars along a projection of the first or second plate can be the same or it can be different from a row of pillars on one projection of the plate to another row of pillars on another projection of the plate as determined through testing and calculations to allow flow sharing between channels and thereby achieving a lower coolant pressure drop, a higher heat transfer rate and a more even flow sharing between the coolant channels. Also, the distance between the pillars and the shape of the pillars and their dimensions can vary along the length of the plate (direction “X”). For example, distances A1, A2 and B1 between the pillars illustrated in FIG. 3B can be different from each other. Furthermore, one flow sharing portion (e.g., 312) between two adjacent pillars, can have a different height (dimension along the direction “Z”) than other flow sharing portions placed on a different projection of the bipolar flow field plate.

FIG. 3C illustrates an embodiment of the bipolar flow field plate of the present invention where the pillars 324 are formed on the second plate 321 of a bipolar flow field plate and have a cylindrical shape with an oval cross-section. The coolant flow is shared between two adjacent coolant flow channels through the flow sharing portions 322 formed on the flat projections 329 of the internal surface of the second plate between the pillars 324.

FIG. 3D illustrates another embodiment of the present invention where the pillars 334 on the projections 337 of the first plate 331 of the bipolar flow field plate, which is next to a membrane electrode assembly 332, have a different shape than the pillars 335 on the projections 338. Pillars 334 have a triangular shape while pillars 335 have a circular shape. Furthermore, pillars 336 on projections 339 have also a triangular shape but are oriented differently along the width of the projection 339 than the triangularly shaped pillars 334. This illustrates that the shape and the positioning of the pillars on the projections of the first and/or of the second plate of the bipolar flow field plate which form its first and second internal surfaces according to the invention can vary from one projection of the plate to the other, according to the flow sharing requirements determined experimentally.

FIG. 3E illustrates another embodiment of the present invention where only the first plate 341 of the bipolar flow field plate 340 which is next to the membrane electrode assembly 342 is provided with coolant flow channels 350 on the first internal surface of the first plate while the second plate 343 has a flat second internal surface 347. The first plate 341 of the bipolar flow field plate 340 is provided with pillars 345 which are molded along the length of the projections 349 on the first internal surface of the first plate 341. The pillars 345 have a triangular shape similar with the shape of the pillars 334 from FIG. 3D. The second plate 343 is provided with pillars 346 on its flat surface 347 and pillars 346 have a round shape similar to pillars 335 from FIG. 3D. The first plate 341 of the bipolar flow field plate 340 is also provided with pillars 348 which are molded along the length of the projections 351 on the first internal surface of the first plate 341 and which have a triangular shape similar to the shape of the pillars 336 from FIG. 3D. The pillars 345 and 348 on the first internal surface of first plate 341 can make contact with the flat internal surface 347 of the second plate 343 and pillars 346 on the flat second internal surface of second plate 343 can make contact with the projections 353 of the first internal surface of the first plate 341.

As seen in FIG. 3E the coolant flow channels can be formed in the bipolar flow field plate by a flat internal surface of one plate and an internal surface on the other plate which is designed to give the coolant flow channel the desired shape. In this embodiment all the coolant flow channels 350 communicate to each other through flow sharing portions 352.

As seen in the figures, for example in FIG. 3B, the flow field channels of the bipolar flow field plate have a constant cross-section along the length of the bipolar flow field plate (direction X).

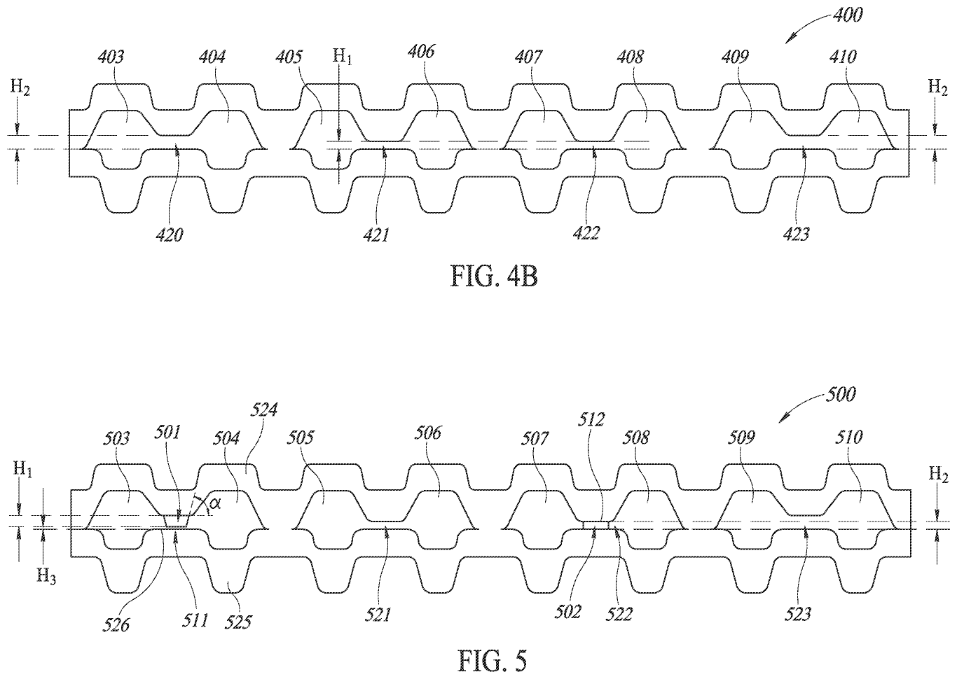

FIGS. 4A and 4B illustrate another embodiment of the present invention. In this embodiment the bipolar flow field plate 400 is provided with molded coolant flow channels where the adjacent coolant flow channels 403 and 404 communicate to each other through coolant flow sharing portion 420, and adjacent coolant flow channels 405 and 406, 407 and 408, 409 and 410 communicate with each other through coolant flow sharing portions 421, 422 and 423, respectively.

In this embodiment the size of the coolant flow sharing portions can be the same or it can be different. For example, coolant flow sharing portions 421 and 422 have the same size (height H₁) and coolant flow sharing portions 420 and 423 also have the same size (height H₂) which is different than the size H₁, respectively bigger than H1 thereby allowing more flow sharing between the adjacent coolant flow channels.

A person skilled in the art would understand that the size of the coolant flow sharing portions can also be the same or it can increase/decrease along the length of the projections of the first internal surface of the first plate or along the second internal projections of the second plate (direction “X”).

FIG. 5 illustrates another embodiment of the present invention. In this embodiment the bipolar flow field plate 500, which comprises a first plate 524 and a second plate 525 which can be glued together or molded into one piece, is provided with molded coolant flow channels where the adjacent coolant flow channels 503 and 504 communicate to each other through coolant flow sharing portion 511, and adjacent coolant flow channels 505 and 506, 507 and 508, 509 and 510 communicate with each other through coolant flow sharing portions 521, 522 and 523, respectively.

In this embodiment, the first plate 524 and/or the second plate 525 of the bipolar flow field plate 500 can be provided on their internal surface with pillars 501, 502 which can be of different shapes and sizes and which can come into contact with the projections on the internal surface of the other plate.

As illustrated, pillar 501, which is provided on the first internal surface of the first plate 524 has a height H₁ and has lateral inclined surfaces at an angle α. Pillar 501 does not touch the surface of the projection 526 of the second plate 525 and it is placed at a distance H₃ from the surface of the projection 526 of the second plate 525 which allows the flow of the coolant underneath the pillar 501. Pillar 502, which is part of the second plate 525 has a different size than pillar 501, having a height H₂, which allows it to touch the surface of the projection 512 of the first plate 524.

As seen in FIG. 5 Flow sharing portions 522 and 523 are different in height.

As in the other embodiments described above, the cross-section of the fuel and oxidant supply channels of the bipolar flow field plate have a constant cross-section along the length of the bipolar flow field plate (direction X).

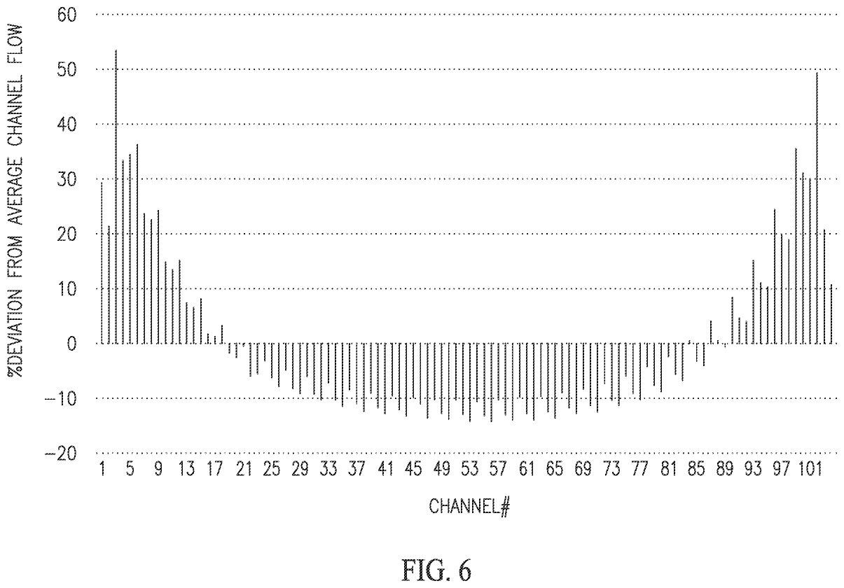

FIG. 6 shows a graphical representation of the deviation from the average coolant channel flow for a fuel cell from the prior art which has a bipolar flow field plate where none of the coolant flow channels do not communicate to each other. As seen in FIG. 5, it was determined through tests that in the bipolar flow field plates from the prior art where there is no fluid communication between the adjacent coolant flow channels, the coolant flow through the coolant flow channels in the middle of the bipolar flow field plate, in a cross-sectional view, is reduced below average while the coolant flow through the channels closer to the ends of the bipolar flow field plate is higher than the average. Based on such tests it can be determined how to improve the flow sharing between channels by implementing the present invention in a bipolar flow field plate where some of the adjacent coolant flow channels communicate to each other, such that all the coolant flow channels have a coolant flow closer to the average.

For example, coolant flow channels 21 to 85 a bipolar flow field plate according to the present invention will be designed to communicate to each other through flow sharing portions with pillars placed on the first internal surface of the first plate or on the second internal surface of the second plate of the bipolar flow field plate. The distance between the pillars placed on one projection of the plate will be different in the “X” direction than the distance between pillars placed on the next projection of the plate and will gradually increase from channel 21 to 53, whereas the distance between the pillars on the projections of the plate corresponding to channels 53 to 85 will gradually decrease. This is because it is needed to have larger distances between the pillars in the channels with worse flow sharing. Also, the height of the coolant flow sharing portions will gradually be increased from channel 21 to 53 and it will gradually be decreased from channel 53 to 85. Consequently, pillars on the projections of the plate that form channel 53 will have the largest distance between them and also the largest height of the coolant flow sharing portion to allow more flow sharing between channels. This will help more flow sharing from channels 1 to 20 and from channels 86 to 101 toward the middle channels 21 to 85 leading to less deviation from the average channel flow. If necessary, the shape of the pillars on the plate projections next to channels 1 to 20 and 86 to 101 could be changed to a triangular shape, similar to the embodiment illustrated in FIG. 3d, so that the pillars would direct the flow towards the middle of the plate.

In all the embodiments of the present invention, the illustrated bipolar flow field plate can be made of graphite or metal.

As described above, all the embodiments of the present invention can comprise a bipolar flow field plate comprising two flow field plates, each flow field plate having a flow field surface provided with landings and flow channels having the construction described above or a single plate molded or manufactured by 3D printing (for metal plates) with the channels having the configuration illustrated in the present embodiments.

The present invention has the advantage that it achieves an appropriate fluid flow sharing between the coolant flow channels and thereby it diminishes the fluid pressure drop along the coolant flow channels and allows a better temperature management of the fuel cell stack thereby increasing the lifetime of the membrane electrode assemblies in the stack. Because in the present invention the thickness of the bipolar flow field plate is not increased while keeping the same size and shape of the fuel and oxidant channels the size of the fuel cell stack can be kept within the required range.

The present invention achieves a lower deviation in each coolant channel flow from the average channel flow, a lower pressure drop in coolant channels, a higher heat transfer rate, leading to a better temperature management of the fuel cell stack thereby increasing the lifetime of the membrane electrode assemblies in the stack and reducing the parasite losses due to the pressure drop. Moreover, because it provides control on the flow sharing in the active area, it minimizes the size of the required transition region between fluid supply and the flow channels thereby reducing the pressure drop in the transition regions and reducing the parasite losses in this regard. In the present invention the cross-section of the fuel supply channels and of the oxidant supply channels remains constant along the length of the flow field plate, as illustrated in the figures, and therefore the flow sharing between the adjacent coolant flow channels can be performed without affecting the flow of the fuel and oxidant flow through the fuel and oxidant supply channels. Also, because in the present invention the thickness of the bipolar flow field plate is not increased along with keeping the same size and shape of the fuel and oxidant channels the size of the fuel cell stack can be kept within the required range.

It will be appreciated that, although specific embodiments have been described herein for the purpose of illustration, various modifications may be made without departing from the spirit and scope of the invention. Accordingly, the invention is not limited except by the appended claims.

1. A bipolar flow field plate for an electrochemical fuel cell, comprising:
a first plate;
a second plate;
fuel supply channels formed on a first external surface of the first plate, the fuel supply channels having a constant cross-section along a length of the bipolar flow field plate;
oxidant supply channels formed on a second external surface of the second plate, the second external surface opposite to the first external surface of the first plate, the oxidant supply channels having a constant cross-section along the length of the bipolar flow field plate; and
coolant flow channels provided within the bipolar flow field plate, formed between a first internal surface of the first plate and a second internal surface of the second plate,
wherein at least two adjacent coolant flow channels in an active area of the bipolar flow field plate communicate to each other through a flow sharing portion, thereby sharing a coolant flow between them.

2. The bipolar flow field plate of claim 1 wherein the coolant flow channels are formed by projections and recesses on the first internal surface of the first plate and by projections and recesses on the second internal surface of the second plate, the projections on the first internal surface of the first plate facing or being in contact with the projections on the second internal surface of the second plate.

3. The bipolar flow field plate of claim 1 wherein the second internal surface of the second plate is planar, and the coolant flow channels are formed by projections and recesses on the first internal surface of the first plate and by the second internal surface of the second plate.

4. The bipolar flow field plate of claim 2, wherein all the adjacent coolant flow channels in the active area of the bipolar flow field plate communicate to each other through flow sharing portions, each flow sharing portion connecting two adjacent coolant flow channels.

5. The bipolar flow field plate of claim 2, wherein only selected adjacent coolant flow channels communicate to each other through flow sharing portions.

6. The bipolar flow field plate of claim 4 wherein at least one of the flow sharing portions which allow the coolant flow sharing between adjacent coolant flow channels is different in height than the other flow sharing portions, thereby allowing more or less flow sharing between adjacent coolant flow channels.

7. The bipolar flow field plate of claim 2 wherein the first internal surface of the first plate is provided with pillars along the length of the projections which form the coolant flow channels, wherein the pillars make contact with the projections on the second internal surface of the second plate which form the coolant flow channels.

8. The bipolar flow field plate of claim 3 wherein the first internal surface of the first plate is provided with pillars along the length of the projections of the first internal surface of the first plate which form the coolant flow channels wherein the pillars make contact with the planar surface of the second internal surface of second plate.

9-10. (canceled)

11. The bipolar flow field plate of claim 7 wherein some of the pillars on one projection of the first internal surface of the first plate are different in size or shape and are placed at a different distance from each other than the pillars on the same projection.

12. The bipolar flow field plate of claim 7 wherein the pillars on one projection of the first internal surface of the first plate are different in size or shape and are placed at a different distance from each other than the pillars on a different projection of the first internal surface of the first plate.

13. The bipolar flow field plate of claim 2 wherein the first internal surface of the first plate is provided with pillars along the length of the projections, wherein at least some of the pillars do not make contact with the projections on the second internal surface of the second plate to allow coolant to flow from one coolant flow channel to an adjacent coolant flow channel.

14. An electrochemical fuel cell stack, comprising more than one fuel cell comprising a membrane electrode assembly wherein each membrane electrode assembly is placed between two bipolar flow field plates, each bipolar flow field plate comprising:
a first plate;
a second plate;
fuel supply channels formed on a first external surface of the first plate, the fuel supply channels having a constant cross-section along a length of the bipolar flow field plate;
oxidant supply channels formed on a second external surface of the second plate, the second external surface opposite to the first external surface of the first plate, the oxidant supply channels having a constant cross-section along the length of the bipolar flow field plate; and
coolant flow channels provided within the bipolar flow field plate, formed by projections and recesses on a first internal surface of the first plate and by projections and recesses on a second internal surface of the second plate,
wherein at least two adjacent coolant flow channels in an active area of a bipolar flow field plate in the stack communicate to each other through a flow sharing portion, thereby sharing a coolant flow between them.

15. (canceled)

16. The electrochemical fuel cell stack of claim 14, wherein only selected adjacent coolant flow channels in the active area of at least one bipolar flow field plate in the stack communicate to each other through flow sharing portions.

17. The electrochemical fuel cell stack of claim 14, wherein at least one of the flow sharing portions which allow the coolant flow sharing between adjacent coolant flow channels of one of the bipolar flow field plates in the stack is different in height, than the other flow sharing portions of the same bipolar flow field plate thereby allowing more or less flow sharing between adjacent coolant flow channels.

18. The electrochemical fuel cell stack of claim 14 wherein the first internal surface of the first plate is provided with pillars along the length of the projections of the first internal surface of the first plate, wherein the pillars make contact with the projections on the second internal surface of the second plate.

19. (canceled)

20. The electrochemical fuel cell stack of claim 18 wherein the pillars are placed at an equal distance from each other along a projection of the first internal surface of the first plate forming the coolant flow channels.

21. The electrochemical fuel cell stack of claim 18 wherein some of the pillars on one projection of the first internal surface of the first plate are different in size or shape and are placed at a different distance from each other than the pillars on the same projection.

22. The electrochemical fuel cell stack of claim 18 wherein the pillars on one projection of the first internal surface of the first plate are different in size or shape and are placed at a different distance from each other than the pillars on a different projection of the first internal surface of the first plate.
